(19) United States
(12) Patent Application Publication
(10) Pub. No.: US 2026/0035278 A1
(43) Pub. Date: Feb. 5, 2026

(54) METHODS AND APPPARTUS FOR FORMING A GLASS RIBBON

(71) Applicant: CORNING INCORPORATED, CORNING, NY (US)

(72) Inventors: Anmol Agrawal, Horseheads, NY (US); Hannah Simone Ellis-Gibbs, New York, NY (US); Cheng Lung Huang, Taichung City (TW); Yi-Ming Liu, Tainan City (TW); Gaozhu Peng, Horseheads, NY (US); Alexander Lamar Robinson, Horseheads, NY (US)

(21) Appl. No.: 19/102,109

(22) PCT Filed: Aug. 22, 2023
(86) PCT No.: PCT/US2023/030771

§ 371 Date: Feb. 7, 2025

Related U.S. Application Data
(60) Provisional application No. 63/373,611, filed on Aug. 26, 2022.

(51) Int. Cl. C03B 17/06

(52) U.S. Cl. CPC C03B 17/064; C03B 17/067

(57) ABSTRACT

A glass forming apparatus includes a cooling tube positioned adjacent to a travel path of a glass ribbon. The cooling tube includes a central portion including a first sidewall surrounding a central chamber and extending along a tube axis. The cooling tube includes an end portion including a second sidewall surrounding an end chamber. The end portion extends along the tube axis and is attached to the central portion. The cooling tube receives a cooling fluid within the central chamber and the end chamber. A sleeve extends along the tube axis and circumferentially surrounds the end portion. The sleeve includes a sleeve wall spaced radially apart from the second sidewall, and a thermally insulating material positioned between the sleeve wall and the second sidewall. Methods of forming a glass ribbon with a glass forming apparatus are provided.

### CROSS-REFERENCE TO RELATED APPLICATIONS

This application claims the benefit of priority under 35 U.S.C. § 119 of U.S. Provisional Application Ser. No. 63/373,611 filed on Aug. 26, 2022, the content of which is relied upon and incorporated herein by reference in its entirety.

### FIELD

The present disclosure relates generally to apparatus and methods for forming a glass ribbon and, more particularly, to methods for forming a glass ribbon with a cooling tube.

### BACKGROUND

It is known to manufacture a glass ribbon with a forming device. Conventional forming devices are known to operate to down draw a quantity of molten material from the glass ribbon forming device as the glass ribbon. The glass ribbon can be cooled while traveling along a travel path. However, while a center portion of the glass ribbon is cooled, end portions of the glass ribbon may be cooled more than desired. This can cause overcooled end portions, which can lead to high stress in the glass ribbon and make the glass ribbon more prone to breakage. Additionally, the overcooled end portions of the glass ribbon can make a transition wall colder and lead to excessive condensation.

### SUMMARY

The following presents a simplified summary of the disclosure to provide a basic understanding of some aspects described in the detailed description.

There are set forth methods of forming glass with a cooling tube. The cooling tube is hollow and filled with a cooling fluid. The cooling tube is positioned adjacent to a glass ribbon and functions to extract heat from the glass ribbon. In aspects, the cooling tube comprises a non-constant diameter, with a central portion of the cooling tube comprising a larger diameter than end portions of the cooling tube. In this way, the central portion of the cooling tube can extract more heat from the glass ribbon than the end portions. In aspects, a sleeve comprising a thermally insulating material may surround the end portions, further reducing the heat extraction by the end portions. In this way, the center of the glass ribbon can be cooled faster than ends of the glass ribbon.

In aspects, a glass forming apparatus can comprise a cooling tube positioned adjacent to a travel path of a glass ribbon. The cooling tube can comprise a central portion comprising a first sidewall surrounding a central chamber and extending along a tube axis. The cooling tube can comprise an end portion comprising a second sidewall surrounding an end chamber. The end portion can extend along the tube axis and may be attached to the central portion. The cooling tube can receive a cooling fluid within the central chamber and the end chamber. The cooling tube can comprise a sleeve extending along the tube axis and circumferentially surrounding the end portion. The sleeve can comprise a sleeve wall spaced radially apart from the second sidewall. A thermally insulating material can be positioned between the sleeve wall and the second sidewall.

In aspects, the central portion can comprise a first outer diameter greater than a second outer diameter of the end portion.

In aspects, the first outer diameter can be in a range from about 40 mm to about 65 mm.

In aspects, the second outer diameter can be in a range from about 10 mm to about 40 mm.

In aspects, the central chamber can comprise a first chamber diameter and the end chamber can comprise a second chamber diameter less than the first chamber diameter.

In aspects, a thickness of the first sidewall can be equal to a thickness of the second sidewall.

In aspects, the sleeve wall can comprise stainless steel.

In aspects, the thermally insulating material can comprise at least one of a ceramic fiber or zirconia.

In aspects, the thermally insulating material can comprise air.

In aspects, the first sidewall can comprise a first coating, the second sidewall can comprise a second coating, and an emissivity of the second coating may be different than an emissivity of the first coating.

In aspects, a glass forming apparatus can comprise a cooling tube positioned adjacent to a travel path of a glass ribbon. The cooling tube can comprise a central portion comprising a first sidewall surrounding a central chamber and extending along a tube axis. The cooling tube can comprise an end portion comprising a second sidewall surrounding an end chamber. The end portion can extend along the tube axis and can be attached to the central portion. The cooling tube can receive a cooling fluid within the central chamber and the end chamber. The cooling tube can comprise a sleeve extending along the tube axis and circumferentially surrounding the end portion. The sleeve can comprise a sleeve wall spaced radially apart from the second sidewall. The sleeve can comprise a first support projection attached to the second sidewall and extending radially between the sleeve wall and the second sidewall. The first support projection can extend along the tube axis. The sleeve can comprise a thermally insulating material positioned between the first sleeve wall and the second sidewall. The thermally insulating material can surround the first support projection.

In aspects, the sleeve can comprise a second support projection extending radially between the sleeve wall and the second sidewall. The second support projection can extend along the tube axis. The first support projection and the second support projection can be spaced circumferentially apart within a range from about 60 degrees to about 90 degrees about the tube axis.

In aspects, the thermally insulating material can be positioned between the first support projection and the second support projection. The thermally insulating material can comprise at least one of a ceramic fiber or zirconia.

In aspects, a first outer diameter of the central portion can be equal to an outer sleeve diameter of the sleeve.

In aspects, the first outer diameter of the central portion can be greater than a second outer diameter of the end portion.

In aspects, methods of forming a glass ribbon with a glass forming apparatus can comprise moving the glass ribbon along a travel path in a travel direction past a cooling tube. Methods can comprise flowing a cooling fluid through the cooling tube. The cooling tube can comprise a central portion positioned adjacent to a central region of the glass ribbon and an end portion positioned adjacent to an edge portion of the glass ribbon. The end portion can be surrounded by a sleeve comprising a thermally insulating material. Methods can comprise extracting heat from the glass ribbon passing the cooling tube such that heat extraction from the central region is greater than heat extraction from the edge portion.

In aspects, the sleeve can comprise a first support projection extending radially between a sleeve wall and the end portion. The first support projection can extend along a length of the sleeve.

In aspects, the central portion can comprise a first outer diameter greater than a second outer diameter of the end portion.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass forming apparatus in accordance with aspects of the disclosure;

FIG. 2 illustrates a perspective cross-sectional view of the glass forming apparatus along lines 2-2 of FIG. 1 in accordance with aspects of the disclosure;

FIG. 3 illustrates a sectional view of a cooling tube along lines 3-3 of FIG. 1 in accordance with aspects of the disclosure;

FIG. 4 illustrates a sectional view of the cooling tube comprising a sleeve in accordance with aspects of the disclosure;

FIG. 5 illustrates an end view of the cooling tube along lines 5-5 of FIG. 4 in accordance with aspects of the disclosure;

FIG. 6 illustrates an end view of additional aspects of the cooling tube in accordance with aspects of the disclosure;

FIG. 7 illustrates a perspective view of additional aspects of the cooling tube in accordance with aspects of the disclosure; and

FIG. 8 illustrates a sectional view of a cooling tube along lines 8-8 of FIG. 7 in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

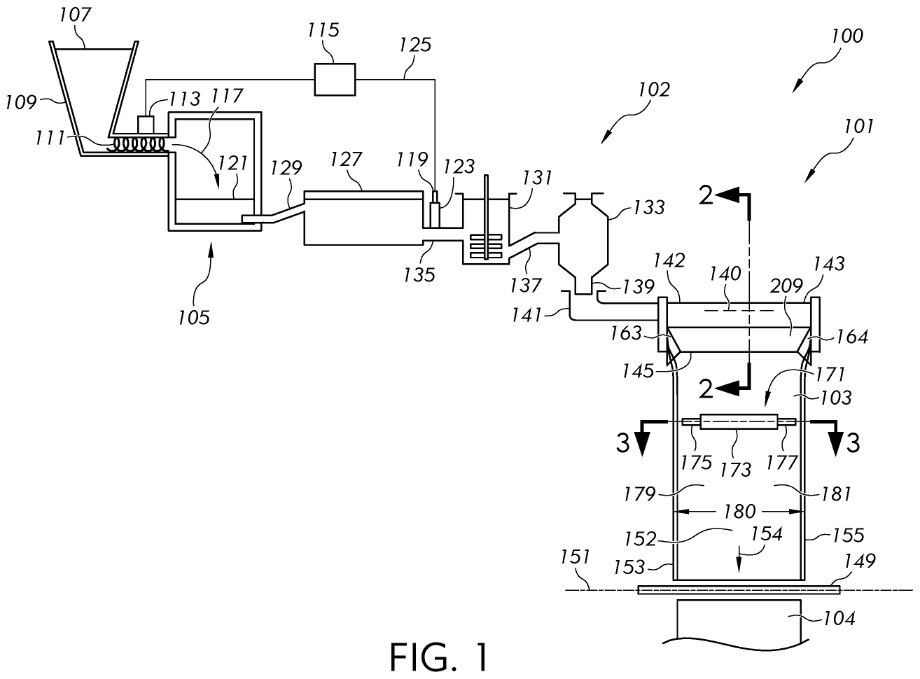

The present disclosure relates to a glass forming apparatus and methods for producing a glass ribbon. Methods and apparatus for producing a glass ribbon from a glass material will now be described by way of example aspects. As schematically illustrated in FIG. 1, in aspects, an exemplary glass forming apparatus 100 can comprise a glass melting and delivery apparatus 102 and a glass ribbon forming device 101 designed to produce a glass ribbon 103 from a quantity of molten material 121. The glass ribbon 103 can comprise a central region 152 positioned between opposite edge portions (e.g., edge beads) formed along a first outer edge 153 and a second outer edge 155 of the glass ribbon 103, wherein a thickness of the edge portions can be greater than a thickness of the central portion. The glass ribbon 103 can comprise the central region 152 positioned between a first edge portion 179 and a second edge portion 181. The first edge portion 179 can comprise the first outer edge 153 and a portion of the glass ribbon 103 inward from the first outer edge 153. The second edge portion 181 can comprise the second outer edge 155 and a portion of the glass ribbon 103 inward from the second outer edge 155. Additionally, in aspects, a separated glass ribbon 104 can be separated from the glass ribbon 103 along a separation path 151 by a glass separator 149 (e.g., scribe, score wheel, diamond tip, laser, etc.).

In aspects, the glass melting and delivery apparatus 102 can comprise a melting vessel 105 oriented to receive batch material 107 from a storage bin 109. The batch material 107 can be introduced by a batch delivery device 111 powered by a motor 113. In aspects, an optional controller 115 can be operated to activate the motor 113 to introduce a desired amount of batch material 107 into the melting vessel 105, as indicated by arrow 117. The melting vessel 105 can heat the batch material 107 to provide molten material 121. In aspects, a melt probe 119 can be employed to measure a level of molten material 121 within a standpipe 123 and communicate the measured information to the controller 115 by way of a communication line 125.

Additionally, in aspects, the glass melting and delivery apparatus 102 can comprise a first conditioning station comprising a fining vessel 127 located downstream from the melting vessel 105 and coupled to the melting vessel 105 by way of a first connecting conduit 129. In aspects, molten material 121 can be gravity fed from the melting vessel 105 to the fining vessel 127 by way of the first connecting conduit 129. For example, in aspects, gravity can drive the molten material 121 through an interior pathway of the first connecting conduit 129 from the melting vessel 105 to the fining vessel 127. Additionally, in aspects, bubbles can be removed from the molten material 121 within the fining vessel 127 by various techniques.

In aspects, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In aspects, molten material 121 can be gravity fed from the fining vessel 127 to the mixing chamber 131 by way of the second connecting conduit 135. For example, in aspects, gravity can drive the molten material 121 through an interior pathway of the second connecting conduit 135 from the fining vessel 127 to the mixing chamber 131.

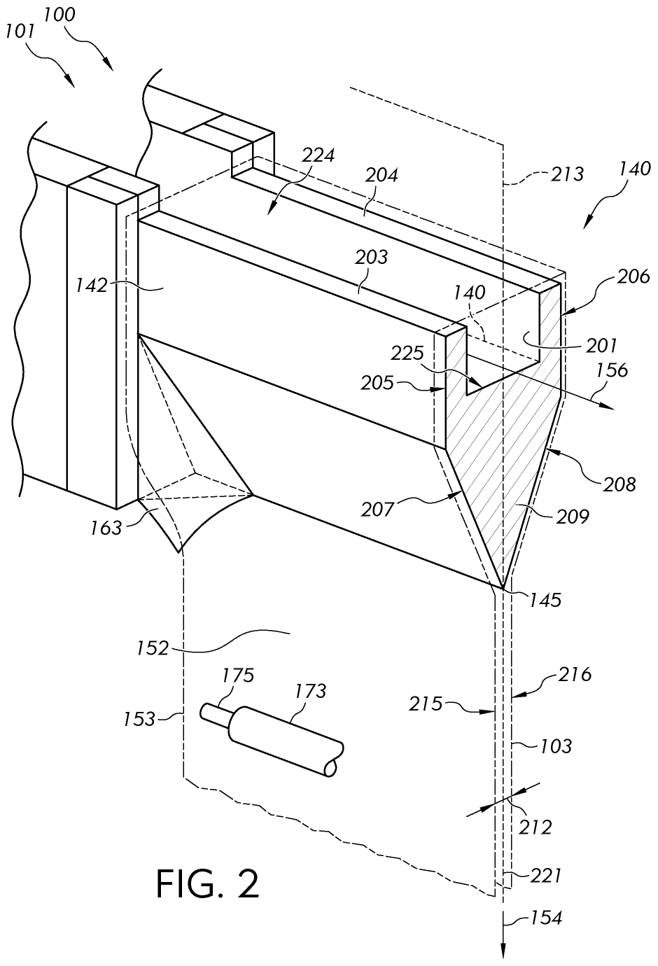

Additionally, in aspects, the glass melting and delivery apparatus 102 can comprise a third conditioning station comprising a delivery chamber 133 that can be located downstream from the mixing chamber 131. In aspects, the delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. In aspects, molten material 121 can be gravity fed from the mixing chamber 131 to the delivery chamber 133 by way of the third connecting conduit 137. For example, in aspects, gravity can drive the molten material 121 through an interior pathway of the third connecting conduit 137 from the mixing chamber 131 to the delivery chamber 133. As further illustrated, in aspects, a delivery pipe 139 can be positioned to deliver molten material 121 to a glass ribbon forming device 101, for example the inlet conduit 141 of the glass ribbon forming device 101. The glass ribbon forming device 101 can comprise a trough (e.g., trough 201 illustrated in FIG. 2) extending along a trough axis 140 between an inlet end 142 and an opposing end 143 of the glass ribbon forming device 101 opposite the inlet end 142. The inlet end 142 is the end of the trough 201 in proximity to the inlet conduit 141 through which the molten material 121 is received. The opposing end 143 is the end farthest from the inlet conduit 141.

By way of illustration, the glass ribbon forming device 101 shown and disclosed below can be provided to fusion draw molten material 121 off a bottom edge, defined as a root 145, of a forming wedge 209 to produce the glass ribbon 103. For example, in aspects, the molten material 121 can be delivered from the inlet conduit 141 to the glass ribbon forming device 101. The molten material 121 can then be formed into the glass ribbon 103 based, in part, on the structure of the glass ribbon forming device 101. For example, as shown, the molten material 121 can be drawn off the bottom edge (e.g., root 145) of the glass ribbon forming device 101 along a draw path extending in a travel direction 154 of the glass forming apparatus 100. In aspects, edge directors 163, 164 can direct the molten material 121 off the glass ribbon forming device 101 and define, in part, a width 180 of the glass ribbon 103. In aspects, the width 180 of the glass ribbon 103 extends between the first outer edge 153 of the glass ribbon 103 and the second outer edge 155 of the glass ribbon 103. The glass forming apparatus 100 can comprise a cooling tube 171 positioned adjacent to a travel path (e.g., travel path 221 of FIG. 2) of the glass ribbon 103. For example, the cooling tube 171 can comprise a central portion 173 positioned adjacent to the central region 152 of the glass ribbon 103 and end portions 175, 177 positioned adjacent to the edge portions 179, 181 of the glass ribbon 103. The cooling tube 171 may be substantially hollow and filled with a cooling fluid that reduces a temperature of an outer surface of the cooling tube 171. In this way, the cooling tube 171 can extract (e.g., absorb, receive, etc.) heat from the glass ribbon 103, thus reducing a temperature of the portions of the glass ribbon 103 adjacent to the cooling tube 171.

In aspects, the width 180 of the glass ribbon 103, which extends between the first outer edge 153 of the glass ribbon 103 and the second outer edge 155 of the glass ribbon 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in aspects. For example, in aspects, the width 180 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

FIG. 2 shows a cross-sectional perspective view of the glass ribbon forming device 101 along line 2-2 of FIG. 1. In aspects, the glass ribbon forming device 101 can comprise a trough 201 oriented to receive the molten material 121 from the inlet conduit 141. For illustrative purposes, cross-hatching of the molten material 121 is removed from FIG. 2 for clarity. The glass ribbon forming device 101 comprises a pair of weirs 203, 204 defining an opening 224 in the trough 201. The glass ribbon forming device 101 comprises a bottom surface 225, which may be substantially planar, and may extend at least partially between the inlet end 142 and the opposing end 143 (e.g., illustrated in FIG. 1). The bottom surface 225 can at least partially define the trough 201, for example, with the bottom surface 225 extending along a bottom of the trough 201 and the pair of weirs 203, 204 extending along opposing sides of the trough 201. The glass ribbon forming device 101 can further comprise the forming wedge 209 comprising a pair of downwardly inclined converging surface portions 207, 208 extending between opposed ends of the forming wedge 209. The pair of downwardly inclined converging surface portions 207, 208 of the forming wedge 209 can converge along the travel direction 154 to intersect along the root 145 (e.g., a bottom edge of the forming wedge 209 where the downwardly inclined converging surface portions 207, 208 meet) of the glass ribbon forming device 101. A draw plane 213 of the glass forming apparatus 100 can extend through the root 145 along the travel direction 154. In aspects, the glass ribbon 103 can be drawn in the travel direction 154 along the draw plane 213. As shown, the draw plane 213 can bisect the forming wedge 209 through the root 145 although, in aspects, the draw plane 213 can extend at other orientations relative to the root 145. In aspects, the glass ribbon 103 can move along a travel path 221 that may be co-planar with the draw plane 213 in the travel direction 154.

Additionally, the molten material 121 can flow in a flow direction 156 into and along the trough 201 of the glass ribbon forming device 101. The molten material 121 can then overflow from the trough 201 by flowing over corresponding weirs 203, 204, through the opening 224, and downwardly over the outer surfaces 205, 206 of the corresponding weirs 203, 204. Respective streams of molten material 121 can then flow along the downwardly inclined converging surface portions 207, 208 of the forming wedge 209 and be drawn off the root 145 of the glass ribbon forming device 101, where the flows converge and fuse into the glass ribbon 103. The glass ribbon 103 can then be drawn along the travel direction 154. In aspects, the glass ribbon 103 comprises one or more states of material based on a vertical location of the glass ribbon 103, i.e., distance from the root 145. For example, at a first location, the glass ribbon 103 can comprise the viscous molten material 121, and at a second location, the glass ribbon 103 can comprise an amorphous solid in a glassy state (e.g., a glass ribbon).

The glass ribbon 103 comprises a first major surface 215 and a second major surface 216 facing opposite directions and defining a thickness 212 (e.g., average thickness) of the glass ribbon 103 therebetween. In aspects, the thickness 212 of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further aspects. For example, in aspects, the thickness 212 of the glass ribbon 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the glass ribbon 103 can comprise a variety of compositions, for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the glass ribbon 103 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. In aspects, none, some, or all, of the glass listed above can be fusion drawn.

In aspects, the glass separator 149 (see FIG. 1) can separate the glass ribbon 104 from the glass ribbon 103 along the separation path 151 to provide a plurality of separated glass ribbons 104 (i.e., a plurality of sheets of glass). In aspects, a longer portion of the separated glass ribbon 104 may be coiled onto a storage roll. The separated glass ribbon can then be processed into a desired application, e.g., a display application. For example, the separated glass ribbon can be used in a wide range of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications.

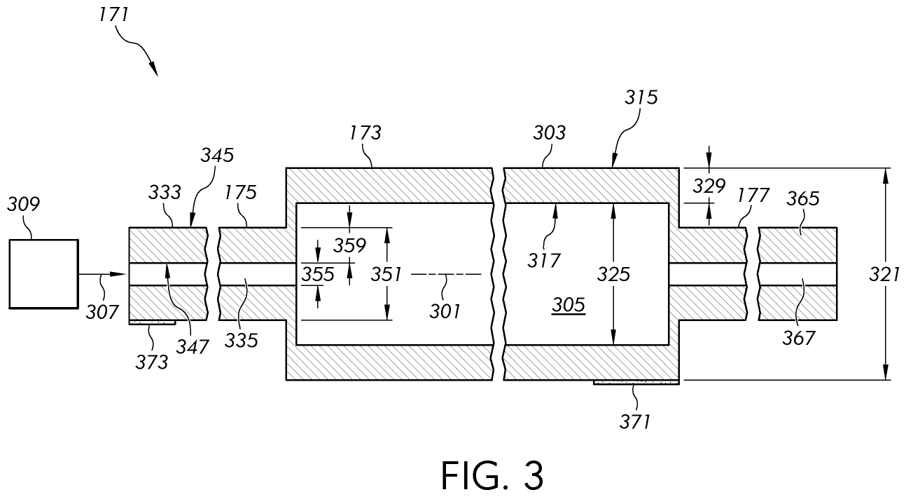

FIG. 3 illustrates a sectional view of the cooling tube 171 as viewed along lines 3-3 of FIG. 1. In aspects, the cooling tube 171 may comprise the central portion 173, the end portion 175, and the second end portion 177 with the central portion 173 positioned between the end portion 175, and the second end portion 177. In aspects, the central portion 173, the end portion 175, and the second end portion 177 can extend along a tube axis 301. The central portion 173 comprises a first sidewall 303 surrounding a central chamber 305 extending along the tube axis 301. In aspects, the central portion 173 may be cylindrical such that the first sidewall 303 can comprise a substantially circular cross-sectional shape. The central chamber 305 may be hollow such that the cooling tube 171 can receive a cooling fluid 307 within the central chamber 305. For example, the cooling fluid 307 can be supplied by a fluid source 309 (e.g., a pump, a cartridge, a liquid vessel, etc.) that may be in fluid communication with the cooling tube 171. By being in fluid communication, the fluid source 309 can be attached to the cooling tube 171 (e.g., via a tube, conduit, pipe, etc.) such that the cooling fluid 307 can be delivered from the fluid source 309 to the central chamber 305. In aspects, the cooling fluid 307 can comprise a liquid, for example, water.

The first sidewall 303 can comprise an outer surface 315 and an inner surface 317. The outer surface 315 can comprise an outer radial surface of the central portion 173 and the inner surface 317 can comprise an inner radial surface of the central portion 173, with the inner surface 317 circumferentially surrounding and bordering the central chamber 305. In aspects, the central portion 173 can comprise a first outer diameter 321, which is measured between opposing sides of the first sidewall 303 at the outer surface 315, intersecting and perpendicular to the tube axis 301. The first outer diameter 321 may be within a range from about 40 millimeters (“mm”) to about 130 mm, or within a range from about 40 mm to about 65 mm, or about 51 mm. In aspects, the central portion 173 can comprise a first chamber diameter 325, which is measured between opposing sides of the first sidewall 303 at the inner surface 317, intersecting and perpendicular to the tube axis 301. The first chamber diameter 325 may be within a range from about 35 mm to about 55 mm, or about 45 mm. In aspects, the first sidewall 303 can comprise a first wall thickness 329, which is measured between the outer surface 315 and the inner surface 317. In aspects, the first wall thickness 329 may be within a range from about 2 mm to about 4 mm, or about 3 mm. In aspects, the first sidewall 303 can comprise a rigid and stiff material that is limited from deformation, for example, a stainless-steel material. The first sidewall 303 may be devoid of holes or openings between the outer surface 315 and the inner surface 317 such that the cooling fluid 307 may not exit the central portion 173 through the first sidewall 303.

The end portion 175 can extend along the tube axis 301 and may be attached to the central portion 173, for example, by being welded to the central portion 173. In aspects, the end portion 175 can extend between a first end, which may be in fluid communication with the fluid source 309, and a second end attached to the central portion 173. The end portion 175 can comprise a second sidewall 333 surrounding an end chamber 335 extending along the tube axis 301. In aspects, the end portion 175 may be cylindrical such that the second sidewall 333 can comprise a substantially circular cross-sectional shape. The end chamber 335 may be hollow such that the cooling tube 171 can receive the cooling fluid 307 within the end chamber 335 and the central chamber 305. For example, the end chamber 335 can be in fluid communication with the fluid source 309 and the central chamber 305, such that the cooling fluid 307 can flow from the fluid source 309, through the end chamber 335, and into the central chamber 305. The second sidewall 333 can comprise an outer surface 345 and an inner surface 347. The outer surface 345 can comprise an outer radial surface of the end portion 175 and the inner surface 347 can comprise an inner radial surface of the end portion 175, with the inner surface 347 circumferentially surrounding and bordering the end chamber 335.

In aspects, the end portion 175 can comprise a second outer diameter 351, which is measured between opposing sides of the second sidewall 333 at the outer surface 345, intersecting and perpendicular to the tube axis 301. The second outer diameter 351 may be within a range from about 12 mm to about 40 mm, or about 25 mm. In aspects, the end portion 175 can comprise a second chamber diameter 355, which is measured between opposing sides of the second sidewall 333 at the inner surface 347, intersecting and perpendicular to the tube axis 301. The second chamber diameter 355 may be within a range from about 10 mm to about 40 mm, or within a range from about 15 mm to about 25 mm, or about 20 mm. In aspects, the second sidewall 333 can comprise a second wall thickness 359, which is measured between the outer surface 345 and the inner surface 347. The second wall thickness 359 may be within a range from about 2 mm to about 4 mm, or about 3 mm. In aspects, the central portion 173 can comprise the first outer diameter 321 which may be greater than the second outer diameter 351 of the end portion 175. In aspects, the second chamber diameter 355 may be less than the first chamber diameter 325. In aspects, the first sidewall 303 and the second sidewall 333 can comprise the same thickness. In aspects, the second sidewall 333 can comprise a rigid and stiff material that is limited from deformation, for example, a stainless-steel material. Like the first sidewall 303, the second sidewall 333 may be devoid of holes or openings between the outer surface 345 and the inner surface 347 such that the cooling fluid 307 may not exit the end portion 175 through the second sidewall 333. Accordingly, due to the differences in respective outer diameters, the central portion 173 may comprise a larger surface area than the end portion 175, such that the central portion 173 can extract more heat from the central region 152 of the glass ribbon 103 than the end portions 175, 177 can from the edge portions 179, 181.

In aspects, the second end portion 177 can be substantially similar or identical to the first end portion 175. For example, the second end portion 177 can extend along the tube axis 301 and may be attached to the central portion 173. That is, the first end portion 175 may be attached to one side of the central portion 173 and the second end portion 177 may be attached to an opposing side of the central portion 173, with the central portion 173 and the first and second end portions 175, 177 extending coaxially along the tube axis 301. The second end portion 177 can comprise a third sidewall 365 substantially identical in material, shape, dimensions, and function as the second sidewall 333. For example, the third sidewall 365 can be hollow and may surround a second end chamber 367 extending along the tube axis 301. The second end chamber 367 can be in fluid communication with the central chamber 305 such that the cooling tube 171 can receive the cooling fluid 307 within the end chamber 335, through the central chamber 305, and through the second end chamber 367. Accordingly, in this way, methods can comprise flowing the cooling fluid 307 through the cooling tube 171. By flowing the cooling fluid 307 through the cooling tube 171, methods can comprise extracting heat from the glass ribbon 103 passing the cooling tube 171 such that heat extraction from the central region 152 may be greater than heat extraction from the edge portions 179, 181.

In aspects, the first sidewall 303 can comprise a first coating 371 and the second sidewall 333 can comprise a second coating 373. For example, the first coating 371 can cover none, some, or all, of the outer surface 315 of the first sidewall 303. In addition, or in the alternative, the second coating 373 can cover none, some, or all of the outer surface 345 of the second sidewall 333. In aspects, the second coating 373 can also cover none, some, or all, of the third sidewall 365 of the second end portion 177. In aspects, an emissivity of the second coating 373 may be the same as, or different than, an emissivity of the first coating 371. The emissivity of the coating is the effectiveness in emitting or receiving energy as thermal radiation, for example, a ratio of the thermal radiation from a surface to the thermal radiation from an ideal black surface. In aspects, the first coating 371 and/or the second coating 373 can comprise, for example, a nickel alloy-based coating. In aspects, the first coating 371 and/or the second coating 373 may comprise a dark shade or no shade. The shade, or surface color, can affect radiation absorption, with white or no shade color absorbing less radiation than a dark or black shade. For example, when the emissivity of the first coating 371 and the second coating 373 is different, the first coating 371 may comprise a dark shade and the second coating 373 may comprise no shade. In the alternative, when the emissivity of the first coating 371 and the second coating 373 is different, the first coating 371 may comprise no shade and the second coating 373 may comprise a dark shade. In this way, the first and second coatings 371, 373 can cause a differing amount of heat extraction from regions of the glass ribbon 103 adjacent to the cooling tube 171. In aspects, the first coating 371 of the central portion 173 can comprise an emissivity of about 0.9 and the end portions 175, 177 may not comprise a coating (e.g., the second coating 373) such that the end portions 175, 177 may comprise an emissivity of about 0.7 (e.g., for stainless steel).

In aspects, the central portion 173 can extract a greater amount of heat (and, thus, achieve greater cooling) than the end portions 175, 177 in several ways. For example, due to the central portion 173 comprising a larger outer diameter than the end portions 175, 177, the central portion 173 can comprise a larger heat transfer area than a heat transfer area of the end portions 175, 177 for the same length. In addition, or in the alternative, an increase in surface emissivity coating can produce an increase in radiation absorbed by the surface, thus increasing heat extraction. Accordingly, a temperature reduction in the middle of the glass ribbon 103 can be greater than a temperature reduction at ends of the glass ribbon 103, due to the central portion 173 being adjacent to the middle of the glass ribbon 103 and the end portions 175, 177 being adjacent to the ends of the glass ribbon 103.

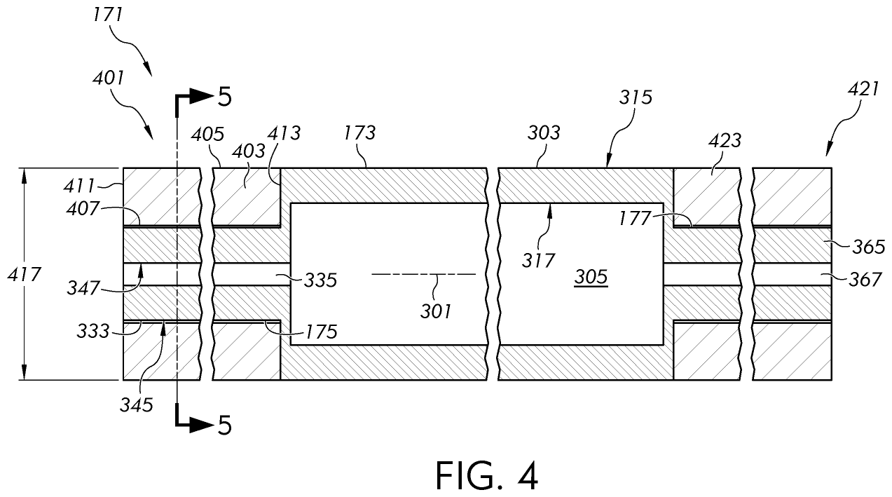

FIG. 4 illustrates a sectional view of additional aspects of the cooling tube 171, for example, with the cooling tube 171 comprising a sleeve 401. The cooling tube 171 may be substantially identical to the cooling tube 171 of FIG. 3, for example, comprising the central portion 173 and the end portions 175, 177. In aspects, the first end portion 175 can be surrounded by the sleeve 401, with the sleeve 401 comprising a thermally insulating material 403. For example, in aspects, the sleeve 401 can comprise a first sleeve wall 405 and a second sleeve wall 407. In aspects, the first and second sleeve walls 405, 407 can comprise stainless steel. The sleeve 401 can extend along the tube axis 301 and circumferentially surround the end portion 175. For example, the sleeve 401 can comprise the first sleeve wall 405 spaced radially apart from the second sidewall 333, with the first sleeve wall 405 located radially outside (e.g., with a larger diameter than) the second sidewall 333. The thermally insulating material 403 can be positioned between the first sleeve wall 405 and the second sidewall 333.

In aspects, the first sleeve wall 405 can be spaced radially apart from the second sleeve wall 407, with the thermally insulating material 403 positioned between the first sleeve wall 405 and the second sleeve wall 407. In aspects, the first sleeve wall 405 is located radially outside (e.g., with a larger diameter than) the second sleeve wall 407. In this way, a gap or space can be provided between the first sleeve wall 405 and the second sleeve wall 407, with the gap or space filled with the thermally insulating material 403 and extending along the tube axis 301. In aspects, the sleeve 401 can extend along the tube axis 301 between a first end and a second end, with a first end of the sleeve 401 co-planar with an end of the end portion 175, and an opposing second end of the sleeve 401 co-planar with an opposing end of the end portion 175 and in contact with the central portion 173. In this way, a length of the sleeve 401 may substantially match a length of the end portion 175. In aspects, the second sleeve wall 407 can be in contact with, and/or attached to, the second sidewall 333, with the second sleeve wall 407 surrounding the second sidewall 333.

In aspects, the thermally insulating material 403 can comprise at least one of a ceramic fiber material or zirconia. The ceramic fiber material comprises a high strength, needled insulating blanket made from spun Fiberfrax ceramic fibers, wherein spun fibers are crosslocked. The ceramic fiber material can comprise a mixture of silicon dioxide and aluminum oxide. In aspects, the sleeve 401 can comprise one or more end walls, such as, for example, a first end sleeve wall 411 and a second end sleeve wall 413. The first end sleeve wall 411 may be located at the first end of the sleeve 401 and may lie within a plane that is perpendicular to the tube axis 301. The second end sleeve wall 413 may be located at the second end of the sleeve 401 and may lie within a plane that is perpendicular to the tube axis 301 and parallel to the first end sleeve wall 411. The first end sleeve wall 411 can be attached to the first sleeve wall 405 and the second sleeve wall 407, for example, by being sealed with the first sleeve wall 405 and the second sleeve wall 407. The second end sleeve wall 413 can be attached to the first sleeve wall 405 and the second sleeve wall 407, for example, by being sealed with the first sleeve wall 405 and the second sleeve wall 407. Accordingly, in this way, the first sleeve wall 405, the second sleeve wall 407, the first end sleeve wall 411, and the second end sleeve wall 413 can define a closed and sealed chamber within which the thermally insulating material 403 is positioned. In aspects, the thermally insulating material 403 is not limited to comprising a structural material (e.g., ceramic fiber, zirconia, etc.), but, rather, may comprise a void. For example, the closed and sealed chamber of the sleeve 401 can be substantially hollow and filled with air, such that the air can act as the thermally insulating material 403. In aspects, the closed and sealed chamber of the sleeve 401 can form a vacuum with air removed. In aspects, a thermal conductivity of the vacuum can be within a range from about 2 Watts/meter*Kelvin to about 4 Watts/meter*Kelvin. The thermally insulating material 403 can reduce heat transfer at the end portions 175, 177, thus reducing the transfer of thermal energy (e.g., heat flow) from the edge portions 179, 181 to the end portions 175, 177. In aspects, a thermal conductivity of zirconia can be within a range from about 1.5 Watts/meter*Kelvin to about 3 Watts/meter*Kelvin. In aspects, a thermal conductivity of the ceramic fiber material can be within a range from about 0.11 Watts/meter*Kelvin to about 0.21 Watts/meter*Kelvin. In comparison, the thermal conductivity of the central portion 173 is higher than the thermal conductivity of the thermally insulating material 403, for example, with the thermal conductivity of the first sidewall 303 within a range from about 15 Watts/meter*Kelvin to about 17 Watts/meter*Kelvin.

In aspects, the sleeve 401 can comprise a sleeve outer diameter 417, with the first outer diameter 321 of the central portion 173 being substantially equal to the sleeve outer diameter 417 of the sleeve 401. In this way, the sleeve outer diameter 417 can be measured between opposing sides of the first sleeve wall 405, intersecting and perpendicular to the tube axis 301. The sleeve outer diameter 417 can be within a range from about 40 mm to about 130 mm, or within a range from about 40 mm to about 65 mm, or about 51 mm. In addition, the cooling tube 171 can comprise a second sleeve 421 surrounding the second end portion 177 and comprising a second thermally insulating material 423. In aspects, the second sleeve 421 may be substantially identical in material, shape, dimensions, and function as the sleeve 401. For example, the second sleeve 421 can comprise sleeve walls that contain the thermally insulating material 403, with the second sleeve 421 comprising a length that substantially matches a length of the second end portion 177 and an outer diameter that substantially matches the first outer diameter 321 of the central portion 173.

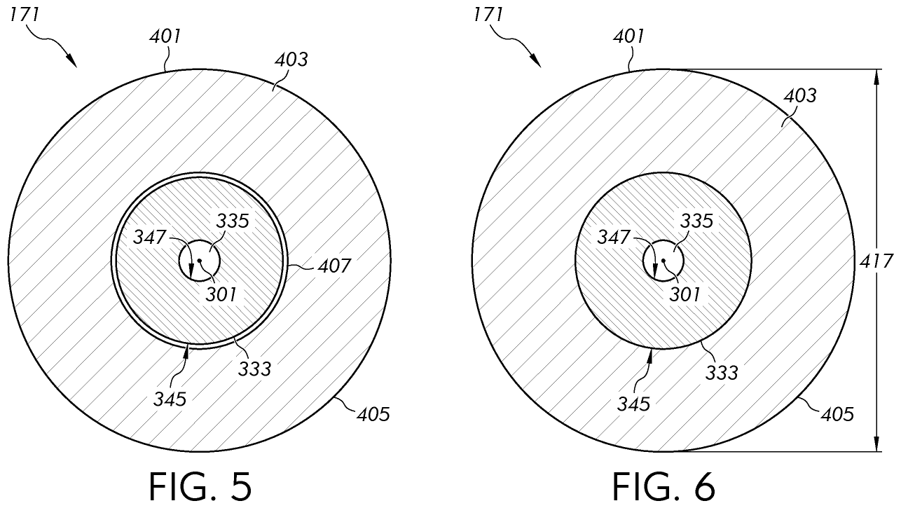

FIG. 5 illustrates a sectional view of the cooling tube 171 comprising the sleeve 401 along lines 5-5 of FIG. 4. As illustrated, in aspects, the second sleeve wall 407 can be adjacent to, and/or in contact with, the outer surface 345 of the second sidewall 333. In this way, the sleeve 401 may be fixed relative to the end portion 175 and limited from moving, for example, in an axial direction along the tube axis 301 and/or in a radial direction perpendicular to the tube axis 301.

FIG. 6 illustrates a sectional view of the cooling tube 171 along lines 5-5 of FIG. 4 similar to FIG. 5, but with additional aspects of the sleeve 401. For example, in aspects, the sleeve 401 is not limited to comprising the first sleeve wall 405 and the second sleeve wall 407. Rather, the sleeve 401 may comprise the first sleeve wall 405 and not the second sleeve wall 407. For example, the sleeve 401 can extend along the tube axis 301 and circumferentially surround the end portion 175, with the sleeve 401 comprising the first sleeve wall 405 spaced radially apart from the second sidewall 333. In this way, the thermally insulating material 403 can positioned between the first sleeve wall 405 and the second sidewall 333, with the thermally insulating material 403 in contact with the outer surface 345 of the second sidewall 333.

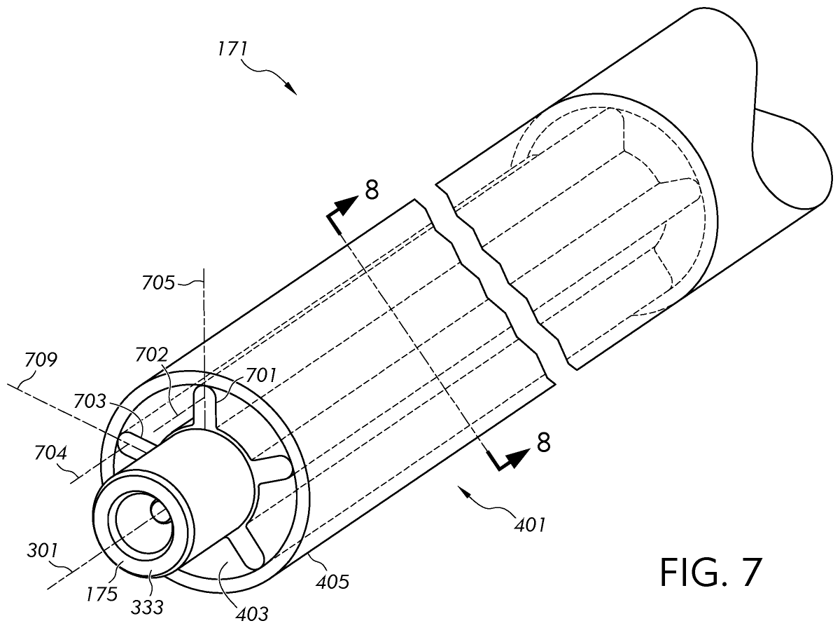

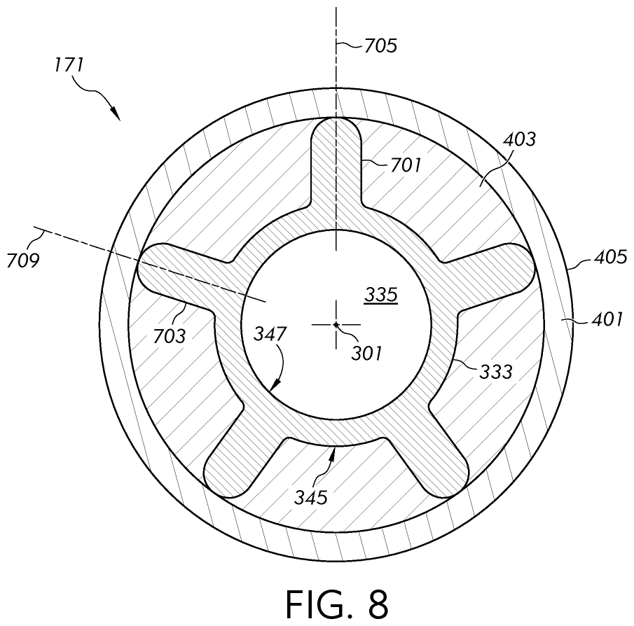

FIGS. 7-8 illustrate additional aspects of the sleeve 401. For example, FIG. 7 illustrates a perspective view of the end portion 175 of the cooling tube 171 with the sleeve 401 surrounding the end portion 175. FIG. 8 illustrates a sectional view of the end portion 175 and the sleeve as viewed along lines 8-8 of FIG. 7. The sleeve 401 comprises the first sleeve wall 405 spaced radially apart from the second sidewall 333. In aspects, the sleeve 401 can comprise one or more support projections, for example, a first support projection 701, a second support projection 703, etc. While FIGS. 7 and 8 illustrate a total of five support projections spaced circumferentially apart about the tube axis 301, any number of support projections can be provided.

The first support projection 701 can be attached to the second sidewall 333 and may extend radially between the first sleeve wall 405 and the second sidewall 333 of the end portion 175. The first support projection 701 can extend along the tube axis 301, for example, by extending continuously along a length of the sleeve 401 between opposing ends of the sleeve 401. In aspects, as illustrated in FIG. 7, the first support projection 701 can extend along a first support axis 702 that is substantially parallel to the tube axis 301. In aspects, the first support projection 701 can extend radially along a first projection axis 705 that intersects, and is perpendicular to, the tube axis 301. In this way, the first projection axis 705 can intersect the first sleeve wall 405 and the second sidewall 333. In aspects, the first support projection 701 can be attached to the first sleeve wall 405 and the second sidewall 333, such that the first sleeve wall 405, the first support projection 701, and the second sidewall 333 may be substantially fixed relative to one another. For example, at an inner radial end, the first support projection 701 may be attached to the second sidewall 333, and at an outer radial end, the first support projection 701 may be attached to the first sleeve wall 405.

The second support projection 703 can be attached to the second sidewall 333 and may extend radially between the first sleeve wall 405 and the second sidewall 333. The second support projection 703 can extend along the tube axis 301, for example, by extending continuously along a length of the sleeve 401 between opposing ends of the sleeve 401. In aspects, as illustrated in FIG. 7, the second support projection 703 can extend along a second support axis 704 that is substantially parallel to the tube axis 301 and the first support axis 702. In aspects, the second support projection 703 can extend radially along a second projection axis 709 that intersects, and is perpendicular to, the tube axis 301. In this way, the second projection axis 709 can intersect the first sleeve wall 405 and the second sidewall 333. In aspects, the second support projection 703 can be attached to the first sleeve wall 405 and the second sidewall 333, such that the first sleeve wall 405, the second support projection 703, and the second sidewall 333 may be substantially fixed relative to one another. For example, at an inner radial end, the second support projection 703 may be attached to the second sidewall 333, and at an outer radial end, the second support projection 703 may be attached to the first sleeve wall 405.

In aspects, the support projections may be spaced apart substantially the same distance circumferentially about the tube axis 301. For example, each of the five support projections of FIGS. 7-8 may be spaced within a range from about 60 degrees to about 90 degrees, or about 70 degrees to about 75 degrees, or about 72 degrees from an adjacent support projection. In this way, the first support projection 701 may be spaced within a range from about 60 to about 90 degrees, or about 70 degrees to about 75 degrees, or about 72 degrees from the second support projection 703 about the tube axis 301. In aspects, the first and second support projections 701, 703 can provide structural support to the sleeve 401 and, thus, to the cooling tube 171. For example, due to the first and second support projections 701, 703 contacting, and, in aspects, attached to, the first sleeve wall 405 and the second sidewall 333, the first and second support projections 701, 703 can limit movement of the sleeve 401 relative to the end portion 175.

In aspects, in addition to providing structural support to the cooling tube 171, the sleeve 401 can thermally insulate the end portion 175. For example, the sleeve 401 can comprise the thermally insulating material 403 positioned between the first sleeve wall 405 and the second sidewall 333. The thermally insulating material 403 can surround the first support projection 701, for example, by being positioned on both sides of the first support projection 701 relative to the first support axis 702. The thermally insulating material 403 can likewise extend along the first support axis 702 along the length of the sleeve 401. In aspects, the thermally insulating material 403 can be positioned in spaces between each of the support projections. For example, the thermally insulating material 403 can be positioned between the first support projection 701 and the second support projection 703, for example, by filling substantially all of the space between the first support projection 701 and the second support projection 703. In this way, the thermally insulating material 403 can be in contact with the first sleeve wall 405 at an outer radial side, with the second sidewall 333 on an inner radial side, and with support projections (e.g., 701, 703) on opposing circumferential sides. Accordingly, in aspects, substantially all portions of the sleeve 401 between the first sleeve wall 405 and the second sidewall 333 may be occupied by either the first and second support projections 701, 703 or by the thermally insulating material 403.

In aspects, the first and second support projections 701, 703 are not limited to being in contact with, and attached to, the second sidewall 333 as illustrated in FIGS. 7-8. Rather, in aspects, and similar to the aspects of the sleeve 401 illustrated in FIGS. 4-5, the sleeve 401 may comprise the second sleeve wall 407. The second sleeve wall 407 may be attached to the support projections (e.g., 701, 703, etc.) such that the support projections (e.g., 701, 703, etc.) can be attached at an inner radial side to the second sleeve wall 407 and at an outer radial side to the first sleeve wall 405. In this way, the support projections (e.g., 701, 703, etc.) may not contact the second sidewall 333, but rather, may extend between the second sidewall 333 and the first sleeve wall 405 while contacting the second sleeve wall 407. The sleeve 401 can be attached to the end portion 175 in a substantially identical manner as illustrated and described relative to FIGS. 4-5, for example, with the second sleeve wall 407 configured to receive the end portion 175, with the second sleeve wall 407 in contact with the second sidewall 333.

By providing differential cooling of the glass ribbon 103 from the cooling tube 171, several benefits can be achieved. For example, the cooling tube 171 can extract more heat from the central region 152 than from the edge portions 179, 181. As such, breakage at the edge portions 179, 181, which may be associated with overcooling of the edge portions 179, 181, may be avoided. Further, condensation buildup, also resulting from overcooling of the edge portions 179, 181, can be reduced, thus reducing the likelihood of damage to the glass ribbon 103. The cooling tube 171 can further be supported by the sleeve 401, for example, the support projections (e.g., 701, 703, etc.), which can limit the cooling tube 171 from sagging or deforming over a period of time. In addition, in aspects, the thermally insulating material 403 can be selected from several materials based on thermal conductivity to achieve a desired amount of cooling from the end portions 175, 177 of the glass ribbon 103. In this way, the thermal conductivity at the end portions 175, 177 of the glass ribbon 103 may be different than, for example, less than, the thermal conductivity at the central portion 173 of the glass ribbon 103.

In aspects, modeling was conducted to determine the temperature changes as a result of heat extraction based on different types of cooling tubes 171. For example, as compared to a cooling tube with a constant diameter of about 50 mm along an entire length of the cooling tube, the cooling tube 171 of FIG. 3 (e.g., with the central portion 173 comprising a diameter of about 50 mm and the end portions 175, 177 comprising a diameter of about 25 mm), the cooling tube 171 of FIG. 3 had a comparative temperature increase at the central region 152 of about 1.5° C. and a comparative temperature increase at each of the edge portions 179, 181 of about 17° C. In this way, the central region 152 was cooled to a lower temperature than the edge portions 179, 181. In further examples, as compared to a cooling tube with a constant diameter of about 50 mm along an entire length of the cooling tube, the cooling tube 171 of FIG. 4 (e.g., with the central portion 173 comprising a diameter of about 50 mm and the end portions 175, 177 comprising a diameter of about 25 mm, and the sleeve 401 comprising the thermally insulating material 403), the cooling tube 171 of FIG. 4 had a comparative temperature increase at the central region 152 of about 4° C. and a comparative temperature increase at each of the edge portions 179, 181 of about 29° C. Again, the central region 152 was cooled to a lower temperature than the edge portions 179, 181. Accordingly, the non-uniform cooling tube 171 can generate differential cooling along the width of the glass ribbon 103.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass forming apparatus comprising:
a cooling tube positioned adjacent to a travel path of a glass ribbon, the cooling tube comprising:
a central portion comprising a first sidewall surrounding a central chamber and extending along a tube axis;
an end portion comprising a second sidewall surrounding an end chamber, the end portion extending along the tube axis and attached to the central portion, the cooling tube configured to receive a cooling fluid within the central chamber and the end chamber; and
a sleeve extending along the tube axis and circumferentially surrounding the end portion, the sleeve comprising a sleeve wall spaced radially apart from the second sidewall, and a thermally insulating material positioned between the sleeve wall and the second sidewall.

2. The glass forming apparatus of claim 1, wherein the central portion comprises a first outer diameter greater than a second outer diameter of the end portion.

3. The glass forming apparatus of claim 2, wherein the first outer diameter is in a range from about 40 mm to about 65 mm.

4. The glass forming apparatus of claim 2, wherein the second outer diameter is in a range from about 10 mm to about 40 mm.

5. The glass forming apparatus of claim 1, wherein the central chamber comprises a first chamber outer diameter and the end chamber comprises a second chamber outer diameter less than the first chamber outer diameter.

6. The glass forming apparatus of claim 1, wherein a thickness of the first sidewall is equal to a thickness of the second sidewall.

7. The glass forming apparatus of claim 1, wherein the sleeve wall comprises stainless steel.

8. The glass forming apparatus of claim 1, wherein the thermally insulating material comprises at least one of ceramic fiber or zirconia.

9. The glass forming apparatus of claim 1, wherein the thermally insulating material comprises air.

10. The glass forming apparatus of claim 1, wherein the first sidewall comprises a first coating, the second sidewall comprises a second coating, and an emissivity of the second coating is different than an emissivity of the first coating.

11. A glass forming apparatus comprising:
a cooling tube positioned adjacent to a travel path of a glass ribbon, the cooling tube comprising:
a central portion comprising a first sidewall surrounding a central chamber and extending along a tube axis;
an end portion comprising a second sidewall surrounding an end chamber, the end portion extending along the tube axis and attached to the central portion, the cooling tube configured to receive a cooling fluid within the central chamber and the end chamber; and
a sleeve extending along the tube axis and circumferentially surrounding the end portion, the sleeve comprising:
a sleeve wall spaced radially apart from the second sidewall;
a first support projection attached to the second sidewall and extending radially between the sleeve wall and the second sidewall, the first support projection extending along the tube axis; and
a thermally insulating material positioned between the first sleeve wall and the second sidewall, the thermally insulating material surrounding the first support projection.

12. The glass forming apparatus of claim 11, wherein the sleeve comprises a second support projection extending radially between the sleeve wall and the second sidewall, the second support projection extending along the tube axis, the first support projection and the second support projection spaced circumferentially apart within a range from about 60 degrees to about 90 degrees about the tube axis.

13. The glass forming apparatus of claim 12, wherein the thermally insulating material is positioned between the first support projection and the second support projection, the thermally insulating material comprising at least one of ceramic fiber or zirconia.

14. The glass forming apparatus of claim 12, wherein a first outer diameter of the central portion is equal to an outer sleeve diameter of the sleeve.

15. The glass forming apparatus of claim 14, wherein the first outer diameter of the central portion is greater than a second outer diameter of the end portion.

16. A method of forming a glass ribbon with a glass forming apparatus comprising:
moving the glass ribbon along a travel path in a travel direction past a cooling tube;
flowing a cooling fluid through the cooling tube, the cooling tube comprising a central portion positioned adjacent to a central region of the glass ribbon and an end portion positioned adjacent to an edge portion of the glass ribbon, the end portion surrounded by a sleeve comprising a thermally insulating material; and
extracting heat from the glass ribbon passing the cooling tube such that heat extraction from the central region is greater than heat extraction from the edge portion.

17. The method of claim 16, wherein the sleeve comprises a first support projection extending radially between a sleeve wall and the end portion, the first support projection extending along a length of the sleeve.

18. The method of claim 16, wherein the central portion comprises a first outer diameter greater than a second outer diameter of the end portion.
